(19) United States
(12) Patent Application Publication
(10) Pub. No.: US 2007/0016333 A1
(43) Pub. Date: Jan. 18, 2007

(54) Method and apparatus for controlling the valve position of a variable orifice flow meter

(76) Inventors: Grant Bradley Edwards, Minneapolis, MN (US); John Allan Kielb, Eden Prairie, MN (US); Dale Alan Nugent, Minneapolis, MN (US)

Correspondence Address: MERCHANT & GOULD PC, P.O. BOX 2903, MINNEAPOLIS, MN, 55402-0903, US

(21) Appl. No.: 11/179,235

(22) Filed: Jul. 12, 2005

(51) Int. Cl. G05D 7/00; G05D 11/00

(52) U.S. Cl. 700/282

(57) ABSTRACT

A device for metering fluid flow is disclosed. The device includes a variable sized orifice defined by a fluid flow conduit and an element movable relative to the fluid flow conduit to vary a size of the orifice, a pressure sensor configured to determine a pressure differential across the orifice and generate a pressure signal, a positioning device configured to determine a position of the element relative to the conduit and generate a position signal, and a processor configured to determine the fluid flow rate using the pressure signal and the position signal. The system can directly control the adjustable valve or orifice. Alternatively, the system can move back and forth between a direct mode and a PID mode. When in a PID mode, the system employs a standard PID algorithm with a variable gain term. The system switches to direct mode when it is advantageous for the controller to directly change the valve position based upon the setpoint, and the input and output pressures.

### FIELD OF THE INVENTION

The present invention generally relates to fluid flow metering and fluid control systems; more particularly relates to improving the response time of a flow control loop and system; and even more particularly improves the control response to changes in a flow setpoint, as well as to changes in the operating conditions (loop pressure) of the control loop.

### BACKGROUND

In flow control systems, a valve may be controlled by an intelligent controller or other CPU based device (e.g., a personal computer). The controller device typically executes some form of a PID (proportional, integral, differential) algorithm to perform the flow control. As an input of the control loop, oftentimes a flow meter provides a flow rate. The controller continuously monitors the flow rate and compares it to a desired flow rate (e.g., the set point). The difference between the actual flow rate and the set point is commonly referred to as the error term. The signal that the controller device generates to drive the valve is dependent upon this error term and the PID terms used by the algorithm. Small error terms require a small change in the signal that drives the valve, and large error terms will require a large change in the signal that drives the valve.

The intended result of the controller device is to keep the flow control loop operating correctly for both changes in the flow set point, and for changes in the operating conditions of the loop. The PID terms in the control algorithm are set to converge on a new set point value or compensate for changes in the control loop conditions as quickly as possible. They are also set to keep the control loop stable (e.g., to avoid loop oscillations). These two functions of the PID terms are typically opposing, as the faster the PID algorithm responds, the less stable the loop will be. However, since control loops must be stable to ensure production processes continue to operate properly and safely, control loop speed is typically sacrificed for loop stability.

For different types of control loops, the specific values of the PID terms will be different. For example flow control loops, which are quite fast, require different PID terms than temperature control loops, which are generally slower. Each type of control loop will have the terms optimized to keep the loop stable, and yet deviate from the control set point as little as possible. The longer the flow control loop deviates from the set point or optimum control value, the longer a user has to wait to start a production process, or worse, the longer the user is producing faulty or suboptimum product. For example, a user may be producing or using very expensive chemicals in the production process, and so may have to discard the chemicals produced while the loop is not at the correct set point. It is therefore desirable for the control loop to respond to a set point change or to a change in the loop operating conditions as quickly as possible.

In typical flow control loops the flow meter and the control valve are independent devices. The flow meter may utilize one of several different technologies to perform the flow measurement. Typical devices include ultrasonic, differential pressure, vortex, paddlewheel, and other technologies. The control valve may also use one of several different technologies. Examples include gate valves, diaphragm valves, pinch valves, ball valves, butterfly valves, or another type of valve. In traditional process plants the controller device resides in an independent device—known as the process control system. The process control system may include a large computer with inputs to read meters and outputs to drive valves. The inputs and outputs are typically 4-20 mA current signals, but may also be voltage signals or a digital communication signal. The process control system may control hundreds of various pressure, temperature and flow control loops throughout a process plant. It contains the PID terms to perform the control function for each of the loops. Each control loop could theoretically have its own unique PID terms stored in the process control system.

A control valve, no matter which technology is employed, has an opening that is varied to increase or decrease the amount of fluid flowing through it. The rate at which fluid flows through the valve is dependent upon the size of this opening, and the inlet and outlet pressures of the valve. Therefore, if the pressure upstream or downstream of the valve changes, the valve opening must be adjusted by the controller in order to maintain a constant flow rate through the valve. Adjusting for these types of changes in the flow loop operating conditions to keep the flow rate constant, is a function of the PID algorithm.

In a common flow control loop, such as that shown in FIG. 1, the controller device does not “know” the operating conditions of the control valve. More specifically, generally the device does not monitor the inlet pressure, the outlet pressure, or the size of the opening of the valve orifice. It simply monitors the flow meter, compares the generated flow meter value to the setpoint, and operates the valve via the PID algorithm. The result is a searching or hunting for the valve position that drives the error term to zero. It is this searching or hunting aspect of the PID algorithm that precludes it from being fast. FIGS. 2a and 2b show an illustrative PID control loop response to a large and a small setpoint change, respectively, while FIGS. 2c and 2d show an illustrative PID control loop response to a large and a small change in the loop conditions, respectively.

To overcome some of the shortcomings of a PID control loop, the loop response to setpoint changes can be measured, determined from a mathematical model, or determined by other means. New setpoint values are then run through a model which uses this predetermined loop response information to optimize the response of the control loop to the new setpoint. However, a drawback to using this method in a flow control loop is that the loop will respond differently for different inlet and outlet pressures and opening sizes of the valve. Therefore the optimization can be achieved for only one given set of operating conditions. Also, this setpoint modeling scheme does not improve the control loop response to changes in the loop operating conditions.

An extension of the setpoint modeling method for improving control loop response to setpoint utilizes a feedforward signal (in conjunction with the controller signal) in an effort to improve the response to a setpoint change. It does this by bypassing the controller and PID algorithm, and directly influencing the signal driving the control valve. However, this scheme has some of the same drawbacks as the optimization scheme discussed above. More specifically, the feedforward signal is independent of the operating conditions of the valve, and the method only improves the control response to setpoint changes, not to changes in the loop operating conditions.

One method that can be used to overcome shortcomings in the PID response to a disturbance in the control loop operating conditions is a method that includes a feedforward disturbance correction scheme. This method may be appropriate if a control loop has a known type of disturbance that occurs, and this disturbance results in causing the loop output to deviate from the desired output for an unacceptably long time. The method involves actually measuring the disturbance (it may be a temperature or pressure deviation), and correcting the deviation by bypassing the controller and PID algorithm to directly affect the valve control signal. This removes the time response of the PID algorithm from the signal that corrects for the disturbance. This method works well if the disturbance is known, if the disturbance can be measured accurately and economically, and if the effect of the disturbance is known.

One drawback to using feedforward disturbance correction is that the feedforward signal is only a correction signal. Therefore, the signal must be applied correctly in conjunction with the PID algorithm. In other words, if the PID response is slow for a particular loop, then the feedforward signal needs to be applied longer than it would be applied for a fast control loop. Also, the feedforward signal is only correcting for one measured loop disturbance. If another, unmonitored disturbance occurs or if a setpoint change occurs during the disturbance, then the feedforward signal could possibly be driving the control valve in the opposite direction than what is desired.

Therefore, there is a need in the art for a flow device that improves response times between changed setpoints of a flow control system whether such setpoint changes are due to an intentional change in the setpoint and/or due to a change based on a disturbance in the flow. Such a system would preferably include a rapid movement to the proximate setpoint setting and then provide closed loop control to maintain the setpoint. The present invention overcomes the shortcomings of the prior art and addresses these needs in the art.

### SUMMARY OF THE INVENTION

The present invention generally relates to fluid flow metering and control systems; more particularly relates to improving the response time of a flow control loop; and even more particularly improves the control response to changes in the flow setpoint, as well as to changes in the operating conditions (loop pressure) of the control system and loop. One aspect of the invention relates to a method of metering fluid flow through a variable orifice. A preferred environment in which the present invention is employed includes controlling the physical position of a restrictive member within the variable orifice, thereby changing the cross sectional area of the orifice.

In one embodiment constructed according to the principles of the present invention, there is provided a device for metering fluid flow, wherein the device is of the type having a variable orifice. The device includes a variable sized orifice defined by a fluid flow conduit and an element movable relative to the fluid flow conduit to vary a size of the orifice, a pressure sensor configured to determine a pressure differential across the orifice and generate a pressure signal, a positioning device configured to determine a position of the element relative to the conduit and generate a position signal, and a processor configured to determine the fluid flow rate using the pressure signal and the position signal.

Another device according to principles of the present invention is a device for measuring and controlling fluid flow. The device includes a conduit having a variable orifice defined by a movable element adapted and configured to engage a surface of the conduit and to control fluid flow in the conduit, a pressure sensor configured to measure pressure in the conduit, a position device configured to determine a position of the movable element relative to the conduit surface, and a processor configured to calculate a discharge coefficient based on the position of the movable element and the measured pressure and to calculate a fluid flow through the conduit. The processor may also be configured to compare the calculated fluid flow to a desired fluid flow and adjust the position of the variable orifice to increase or decrease fluid flow as required.

The present invention provides for the ability to operate directly to control the adjustable valve or orifice. Alternatively, a system employing the principles of the present invention may move back and forth between a direct mode and a PID mode. When in a PID mode, the system employs a standard PID algorithm with a variable gain term to optimize performance for the given hardware. The system switches to direct mode when it is advantageous for the controller to directly change the valve position based upon the setpoint, and the input and output pressures.

Therefore, according to one aspect of the invention, there is provided a control system for controlling the flow of fluid through a variable orifice, comprising: a sensor for determining the pressure differential across the orifice and for creating a pressure signal; a sensor for determining the position of a movable restrictive element and for creating a position signal, the element defining at least a portion of the orifice; and a controller for monitoring the pressure signal and the position signal, the controller having a first control algorithm of PID control and a second control algorithm of direct movement of the moveable restrictive element within the orifice.

According to another aspect of the invention, there is provided a method of metering fluid flow through a variable orifice, the method comprising the steps of: controlling a restrictive element located within the orifice to vary the cross-sectional area defined by the variable orifice; measuring a pressure differential across the variable orifice; and switching between a first control algorithm and a second control algorithm when a predetermined pressure differential is reached.

While the invention will be described with respect to preferred embodiment configurations and with respect to particular devices used therein, it will be understood that the invention is not to be construed as limited in any manner by either such configuration or components described herein. Also, while the particular types of variable orifices and pressure sensors are described herein, it will be understood that such particular orifices and sensors are not to be construed in a limiting manner. Instead, the principles of this invention extend to any environment in which fluid control is desired. These and other variations of the invention will become apparent to those skilled in the art upon a more detailed description of the invention.

The advantages and features which characterize the invention are pointed out with particularity in the claims annexed hereto and forming a part hereof. For a better understanding of the invention, however, reference should be made to the drawings which form a part hereof and to the accompanying descriptive matter, in which there is illustrated and described a preferred embodiment of the invention.

### BRIEF DESCRIPTION OF THE DRAWINGS

The illustrative embodiments may best be described by reference to the accompanying drawings where:

FIG. 1 is a block diagram illustrating the elements of a prior art flow control loop.

FIG. 2a is a diagram illustrating a representative PID response to a large setpoint change.

FIG. 2b is a diagram illustrating a representative PID response to a small setpoint change.

FIG. 2c is a diagram illustrating a representative PID response to a large control loop condition change.

FIG. 2d is a diagram illustrating a representative PID response to a small control loop condition change.

FIG. 3 is a top perspective view of a flow device according to principles of the invention.

FIG. 4 is a top plan view of the flow device shown in FIG. 3.

FIG. 5 is a cross-sectional view of one example configuration of the flow device shown in FIG. 4 taken along cross-section indicators 5-5.

FIG. 6 is a cross-sectional view of the example flow device shown in FIG. 5 taken along cross-section indicators 6-6.

FIG. 7 is an enlarged view of the orifice and movable element portion of the device shown in FIG. 5.

FIG. 8 is a cross-sectional view of the example flow device shown in FIG. 4 taken along cross-section indicators 8-8.

FIG. 9 is a cross-sectional view of the example flow device shown in FIG. 4 taken along cross-section indicators 9-9, the example device having a rectangular inlet to the orifice.

FIG. 10 is a cross-sectional view of the example flow device shown in FIG. 4 taken along cross-section indicators 10-10.

FIG. 11 is a cross-sectional view of an alternative embodiment of the example flow device shown in FIG. 4 taken along cross-section indicators 11-11, the example device having a circular inlet to the orifice.

FIG. 12 is a functional block diagram of the various elements of an embodiment constructed in accordance with the principles of the present invention.

FIG. 13 is a functional block diagram illustrating the principles of the control system of the present invention.

FIG. 14 is a logic flow diagram of the programming steps that a controller block 225 of FIG. 13 might employ to switch between a direct movement mode and a PID control mode.

FIG. 15a is a diagram illustrating a representative response to a large setpoint change using direct mode.

FIG. 15b is a diagram illustrating a representative response to a small setpoint change using direct mode.

FIG. 15c is a diagram illustrating a representative response to a large control loop condition change using direct mode.

FIG. 15d is a diagram illustrating a representative response to a small control loop condition change using direct mode.

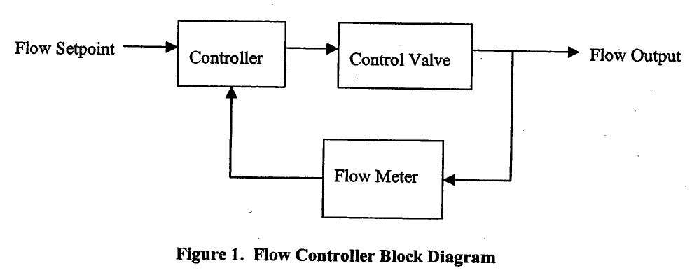

### DETAILED DESCRIPTION

The invention generally relates to fluid flow metering and control devices, and more particularly relates to variable-sized orifice flow devices and systems for controlling the fluid flow through such flow devices. The variable-sized orifice may be particularly suited for use in a differential pressure flow meter as will be described herein with reference to the several drawings, although such an application is only exemplary of the many applications to which principles of the present invention may be applied.

In order to more clearly describe the present invention, a detailed description of the flow control system will be deferred pending a description of the preferred environment variable orifice device with which the present invention is employed.

Example Flow Device

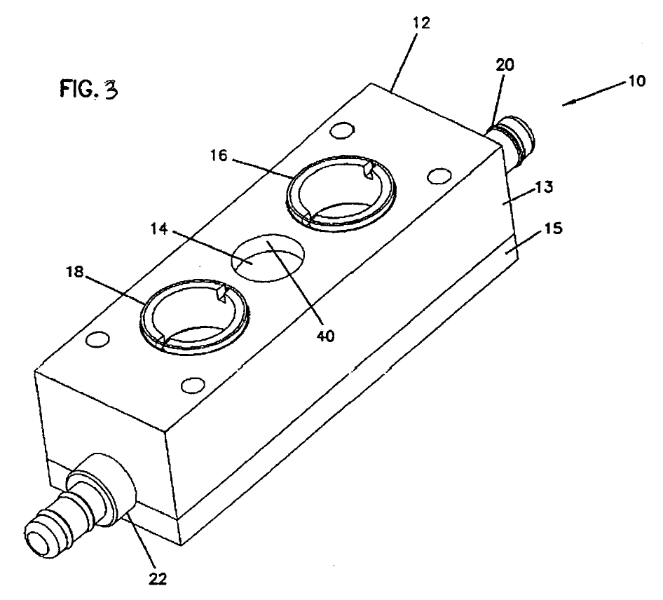

An example flow device 10 constructed in accordance with the principles of the present invention for controlling and metering fluid flow is shown in FIGS. 3-11. The device includes a housing 12, a moveable element 14, first and second pressure sensors 16, 18, and inlet and outlet conduit connectors 22, 20. A conduit 30 is formed through the housing and includes first, second and third segments 50, 52, 54. The housing also includes first and second sensor bores 36, 38 that intersect with the conduit 30 in a direction transverse to the conduit 30, and an element bore 40 that also intersects with conduit 30 in a direction transverse to conduit 30. In this example, element bore 40 and sensor bores 36, 38 extend parallel to each other, but may be aligned perpendicular to each other in other embodiments. Housing 12 may be divided into separate pieces or halves 13, 15 (see FIG. 3) to facilitate precise formation of intricate features within the housing, or may be integrally formed as a single piece.

Moveable element 14 includes a base 42 and a contact member 44, and is positioned in element bore 40 so as to extend into second segment 52 of the conduit 30. Contact member 44 includes a leading edge 46, a tapered trailing edge 48, and a planar contact surface 49 (see FIG. 7) configured to mate with a planar surface (for example, fixed wall 90 described below and shown in FIG. 7) of second segment 52. The movable element 14 is moveably adjustable along a linear axis through a range of positions between an open (retracted) position and a closed (extended) position, with movement of the movable element 14 being limited to the linear axis. The open position allows a maximum fluid flow through the conduit 30. The fluid flow through the conduit 30 decreases as the movable element 14 is moved toward the closed position due to contact with the fluid. Adjustment of the movable element 14 in element bore 40 may be performed using, for example, a linear actuator, a stepper motor, a hydraulic or pneumatic actuator, a solenoid, a servo motor, or a manual device such as a threaded shaft with a thumb turn button. The position of the movable element 14 may be determined using, for example, a Hall effect sensor, magnetostrictive devices, linear variable differential transformers (LVDTs), optical encoders, and other position determining technologies.

Limiting movement of element 14 to linear motion within element bore 40 may simplify positioning of movable element 14. Other methods may “infer” a position of the moveable element 14 based on incremental movement related to the moveable element. In one example method, the movable element 14 may be moveable a certain number of steps from a reference position such as a fully open or fully closed position. Software controlling the device 10 may be programmed to convert the number of steps traveled into the distance traveled. An independent position measuring device would not be needed in such a configuration, which may reduce the amount and complexity of hardware used for device 10. A possible drawback of this method is the potential for inaccurate position measurements if the element becomes locked in a single position and the processor thinks that the element is moving a certain number of steps when the element is actually stationary. An encoder used with a stepper motor or with a linear actuator, or other devices that “infer” a linear position from related incremental movement may have similar issues of potential inaccuracy.

Second segment 52 includes an inlet portion 60, an outlet portion 62, and an orifice portion 64 positioned between the inlet and outlet portions 60, 62. The inlet portion 60 is in fluid communication with sensor chamber 32 at one end, and includes a plurality of tapered surfaces at a second end adjacent to the orifice portion 64. Similarly, outlet portion 62 is in fluid communication with sensor chamber 34 at one end, and includes a plurality of tapered surfaces at an opposing end adjacent to orifice portion 64.

The inlet and outlet portions of the orifice segment of the device include a plurality of fixed sidewalls that define a noncircular cross-section in this embodiment. Other embodiments may include inlet and outlet portions of the orifice segment that have a circular cross-section (see example cross-section of inlet portion 160 in FIG. 11), which configuration may be preferred in some instances. The example first and third portions 60, 62 include four fixed walls substantially in the shape of a square (see example cross-section of inlet portion 60 in FIG. 9). As used throughout this document, rectangular is defined as a four-walled shape and a square is defined as a rectangle that has four walls of the same length. The walls of a rectangle are substantially flat or linear and the intersection of two walls provides an angle of about 90°. In some applications, the corners of the rectangle may be tapered slightly with a round, fillet, chamfer or like feature as a result of manufacturing limitations. Further, a portion of one or more of the walls may be slanted or chamfered slightly to create sealing points or to meet other design goals and/or address manufacturing limitations. In embodiments that include a combination of linear and curved walls (not shown), the intersection of these walls may also include features such as rounds, fillets, chamfers, etc. Finally, a portion of one or more of the walls may be formed by the exposed face of a gasket or seal.

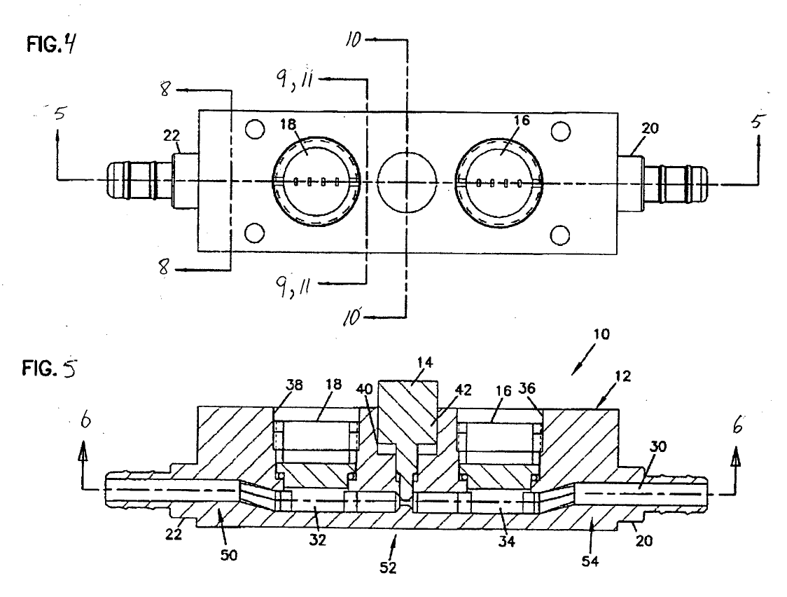

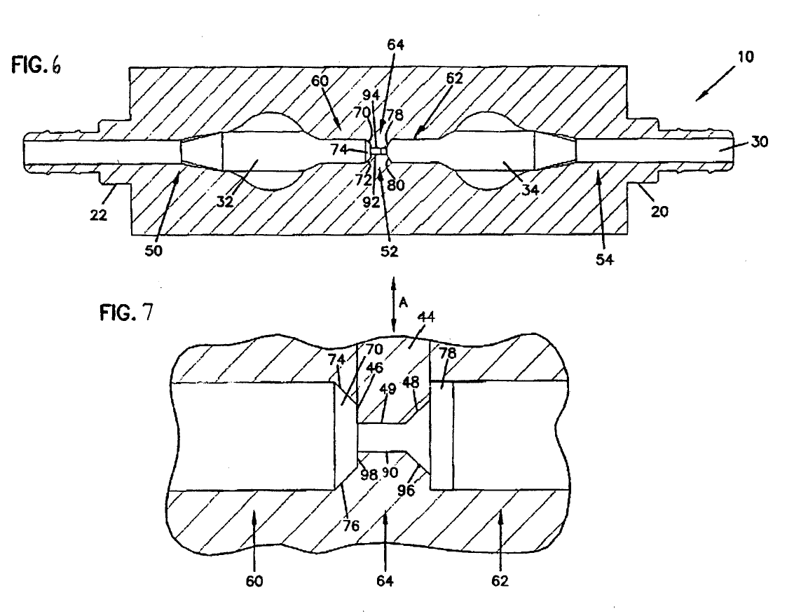

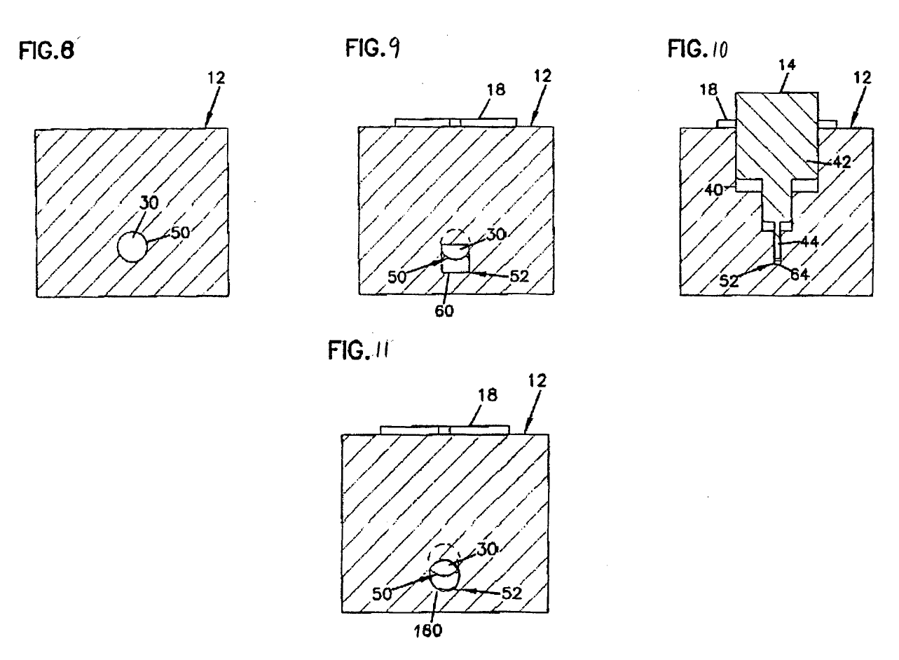

Tapers 70, 72, 74, 76 are formed in the sidewalls of inlet portion 60 to reduce the cross-sectional area at the point where inlet portion 60 abuts to orifice portion 64. The tapers 70, 72, 74, 76 are aligned at a single axial position so as to create a reduction in cross-sectional area of portion 60 in a single step (see FIG. 5-7). Outlet portion 62 also includes a square shaped cross-section with tapered surfaces 78, 80 (see FIG. 6) on opposing sidewalls so as to reduce the cross-sectional area of outlet portion 62 at the transition point between orifice portion 64 and outlet portion 62.

Orifice portion 64 includes three fixed walls 90, 92, 94 with fixed wall 90 including a tapered trailing edge 96 and a leading edge 98 (see FIG. 7). As a result, the cross-sectional area of orifice portion 64 tapers out to the larger cross-sectional area of portion 62 in two steps with sets of tapers 96, 48 and 78, 80. As shown in the cross-sectional view of FIG. 10, orifice portion 64 has a relatively small cross-sectional area as compared to the cross-sectional area of inlet portion 60 shown in FIG. 9.

The leading edges 46, 98 and trailing edges 96, 48 of moving element 44 and orifice portion 64, respectively, provide consistent flow characteristics into and out of the orifice portion 64. A cross-sectional size of the orifice portion 64 is determined by the location of the movable element 14 in relation to the fixed walls 90, 92, 94 of the orifice portion 64. The orifice portion 64 is void of sensor openings and dead volume spaces to avoid disruptions to the fluid flow and potential accumulation of process material or sediment.

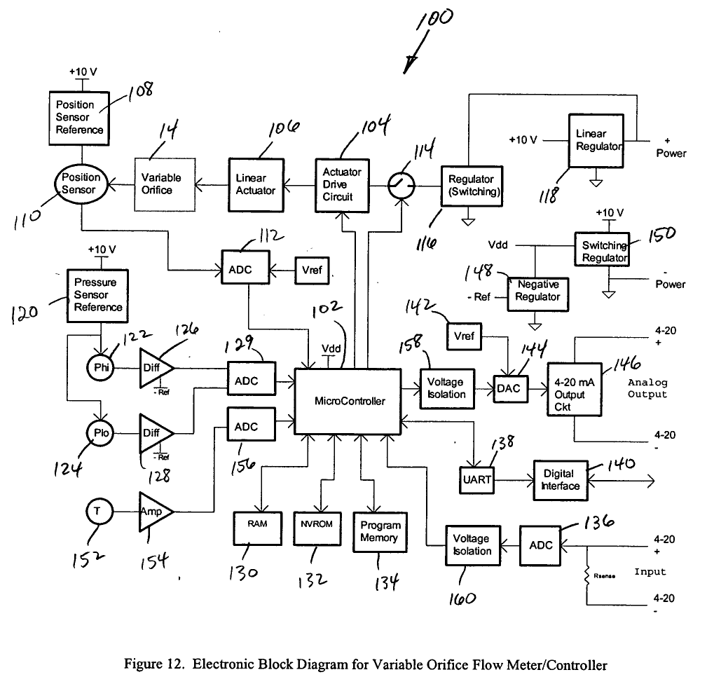

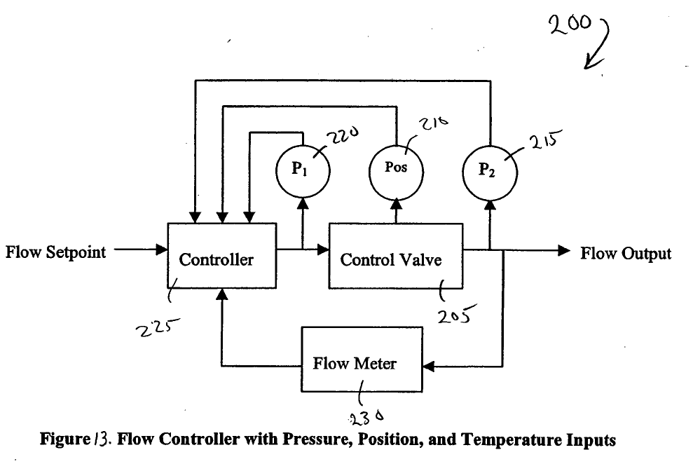

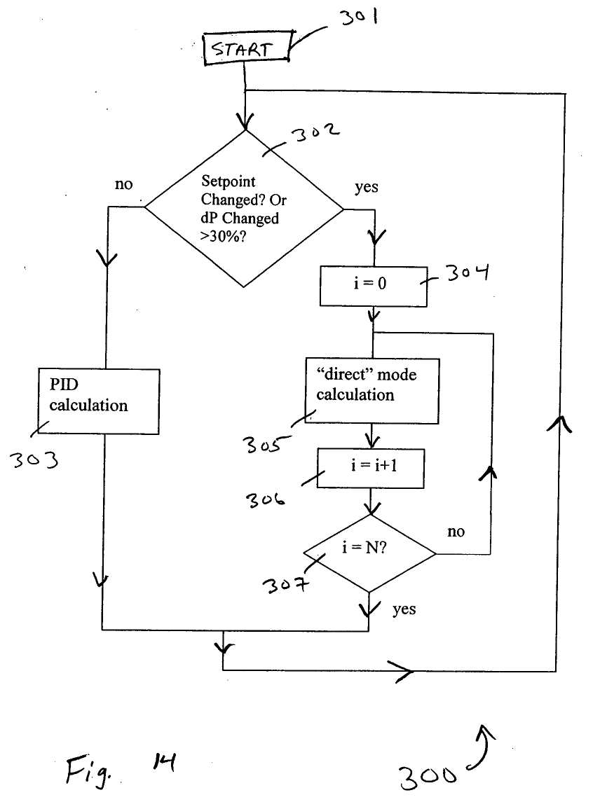

A linear actuator (best seen as block 106 of FIG. 12) is used to effect movement of the movable element 14. By moving along a single linear axis, the movable element 14 linearly changes the cross-sectional size of the orifice portion 64 while maintaining a generally uniform shape to provide a relatively consistent set of flow characteristics through the range of movable element positions. The cross-sectional shape of orifice portion 64 allows repeatable regulation of the fluid flow in accordance with the position in the range of positions of the movable element 14. In one example wherein the uniform shape is a rectangle, the height of the cross-sectional area of the orifice portion 64 is reduced in size as the movable element 14 moves between the open and closed positions. Maintaining a rectangular shape, or at least a shape having at least one planar or linear sidewall, minimizes variations in flow characteristics—thus reducing errors when determining the flow rate for each orifice size.

In use, fluid first enters flow device 10 (which example will be used for the remainder of the description of various aspects of the invention) through first segment 50 of conduit 30. The flow through segment 50 has flow characteristics that match the circular cross-section of first segment 50. The flow then enters the open sensor chamber 32 where a transition volume is provided prior to the fluid flow entering the non-circular inlet portion 60 of second segment 52. The flow is then reduced in cross-sectional area by the several tapers formed in inlet portion 60 just before orifice portion 64. As mentioned above, a higher pressure is generated at the inlet to orifice portion 64 due to the very small cross-sectional area of orifice portion 64 and the wall-like structure created by leading edges 46, 98. The cross-sectional area of orifice portion 64 is dependent on the position of moveable element 14 in the direction A. Each position along the direction A corresponds to a different cross-sectional area of the orifice portion 64 for use in determining the volumetric flow through the flow device 10.

As the fluid exits the orifice defined by the orifice portion 64 and the moveable element 14, the cross-sectional area of the fluid flow increases due to tapers 78 and 80 and trailing edges 48 and 96. The cross-sectional area of outlet portion 62 preferably has the same size and shape as the cross-section of inlet portion 60 (which is a square cross-section in the example flow device in flow device 10—best seen in FIG. 9). Flow exiting outlet portion 62 enters sensor chamber 34 where another transition volume is provided before the fluid flow enters the third segment 54 and takes on a flow pattern for the circular cross-section of third segment 54.

The first and second pressure sensors 16, 18 are positioned at opposing sides of orifice portion 64 so as to be able to determine a difference in pressure at the inlet and outlet sides of second segment 52 of conduit 30. The first and second pressure sensors 16, 18 may be mounted proximate the process liquid to minimize the amount of dead volume of the fluid and reduce crystallization and particle buildup between the first and second pressure sensors 16, 18 and the fluid in conduit 30. In other aspects of the present invention, a single differential pressure sensor may be used to communicate with both the first and second sensor chambers 32, 34 to determine the pressure difference. Furthermore, only a single pressure sensor may be required in applications where one of the first or second sensor chamber 32, 34 has a fixed pressure. For example, if the second sensor chamber 34 is downstream of the orifice and empties into an open tank at atmospheric pressure, a downstream pressure measurement is not required and the pressure measurement from the first sensor 16 may be used singly with atmospheric pressure to determine the pressure differential. Likewise, if the first sensor chamber 32 is upstream of the orifice portion 64 and is accepting liquid from a pressurized tank where pressure is tightly controlled to a fixed value, an upstream pressure is not required and the pressure measurement from the second sensor 18 may be used singly with the fixed upstream pressure value to determine the pressure differential.

Other example embodiments may use a single differential pressure sensor that takes pressure readings from the inlet and outlet sides of the orifice portion of the device and determines a differential pressure across the orifice portion. This and other types of sensors do not necessarily have to be mounted in a sensor bore, nor does the sensor bore being used require a larger cross-sectional area than the cross-sectional area of the conduit. For example, a sensor may be configured to obtain pressure readings using a small probe that requires a very small entrance opening into the conduit relative to the conduit size, and the sensor can be mounted at a different location within or adjacent to the device housing.

Yet further embodiments may not include any sensors associated directly with the device, but may be configured to use pressure signals provided by outside sources. Such pressure readings from an outside source may include, for example, a pressure reading from a pressure sensor positioned up or down stream from the device, or a pressure signal representative of a know static pressure condition for the system either up or down stream of the device. Thus, although the device does not require a pressure sensor, the device is preferable configured to use a pressure signal for purposes of metering and controlling fluid flowing through the device.

A pressure signal representing a pressure differential across an orifice may be used with the cross-sectional area of the orifice, the cross-sectional area of the inlet and outlet portions just before and after the orifice, and the density of the fluid to determine the volumetric flow rate.

An advantage of the present invention is that when preferred embodiment devices are utilized in an environment in which such devices are employed as a flow meter, then the pressure signal (ΔP) may be optimized at each flow rate by varying the orifice size. For example, the pressure signal may be set at a minimum value for a given flow rate by varying the orifice size. Furthermore, the pressure signal may be optimized for a desired flow rate or inlet pressure by varying the orifice size. When the preferred embodiment devices are utilized in an environment in which such devices are employed as a flow controller, then the inlet and outlet pressures are fixed and a single orifice opening is defined to achieve the desired flow rate.

Furthermore, although the cross-sections of the inlet, outlet and orifice portions 60, 62, 64 of second segment 52 are shown having a rectangular shape, it may be appreciated that the cross-sections may be cross-sections of different shapes, such as, but not limited to, rectangles, isosceles triangles or the like. Furthermore, different portions of the second segment 52 may have dissimilar cross-sectional shapes and sizes, and may have varying shapes or sizes along a length of each portion of the second segment 52. Additionally, although the orifice portion 64 has a rectangular cross-section, the leading and trailing portions of the orifice portion 64 defined by the leading and trailing edges 46, 48 of the movable element 14 and the leading and trailing edges 98, 96 of the fixed walls 90, 92, 94 may be of different sizes, shapes and orientations than those shown in the Figures.

Functional Elements

Features of the preferred embodiment flow device 10 shown in FIGS. 3-11 are shown schematically as part of a flow device assembly 100 in FIG. 12. Assembly 100 includes a microcontroller 102 that controls and communicates with most of the other assembly features. Assembly 100 includes a actuator drive circuit 104, a linear actuator 106, a position sensor reference 108, a position sensor 110, and an analog-to-digital converter (ADC) 112 that relate to the flow device variable sized orifice, and a switch 114, regulator 116, switching regulator 150, and linear regulator 118 that control power to the blocks 106, 108, 110, 112. Microprocessor 102 may be any suitable processor or controller such as, for example, the HD64F3062 16-bit microprocessor manufactured by RENESAS of San Jose, Calif.

The assembly 100 also includes a pressure sensor reference 120, a high pressure sensor 122, a low pressure sensor 124, and difference amplifiers 126, 128 and an ADC 129 that together are used to determine a pressure differential in the flow device. Different memory devices such as RAM 130, NVROM 132, and program memory 134 may be used by the microprocessor 102 to store data, such as the logical programming steps set forth in FIG. 14 (and/or the PID equations discussed below), instructions, code, algorithms, etc.

The microprocessor 102 may receive inputs in the form of current signals having a magnitude of, for example, 4-20 mA that are converted to digital signals using ADC 136, and may communicate with direct digital signals through a UART 138 and a digital interface 140. Microprocessor 102 may also generate output signals that are converted to analog signals with the voltage reference 142, digital-to-analog converter (DAC) 144 and an output circuit 146 that generates signals having a magnitude of, for example, 4-20 mA. Assembly 100 may use a power source that includes a negative regulator 148 and the switching regulator 150 for powering various features of the assembly 100.

Temperature input 152 is provided to the microprocessor 102 via amplifier 154 and ADC block 156. Voltage isolation blocks 158 and 160 may be provided to isolate the microprocessor 102 from input and output devices.

In response to pressure signals from the pressure sensor blocks 122 and 124, the microprocessor 102 may determine to change the physical position of the valve of the variable orifice. To do so, the microprocessor 102 utilizes the actuator drive circuit block 104 to engage the linear actuator 106. This in-turn moves the variable orifice 14 (e.g., the valve). The position sensor 110 may provide feedback on the actual or implied location of the variable orifice 14.

The microprocessor 102 computes flow by measuring the pressure drop across a variable orifice 14. This variable orifice serves as the restriction for a differential pressure based flow meter, and may also serve as the valve to control the flow rate. Therefore, to perform flow control, a valve separate from the flow meter is not required. Therefore, the components shown in FIGS. 3-11, combined with microprocessor based electronics of FIG. 12 form a complete flow meter/controller.

Because the variable orifice 14 shown in FIG. 12 also performs the valve function when used for flow control, the pressure upstream and downstream of the valve orifice is monitored. The position sensor block 110 monitors the position of the “piston” element 14 which slides back and forth to vary the size of the orifice. Also shown in FIG. 12 is a temperature sensor block 152 which preferably physically resides in the upstream pressure sensor. This temperature sensor 152 is mounted in close proximity to the diaphragm of the pressure sensor and is used to monitor the temperature of the fluid flowing through the meter/controller.

Control Methods and Apparatus

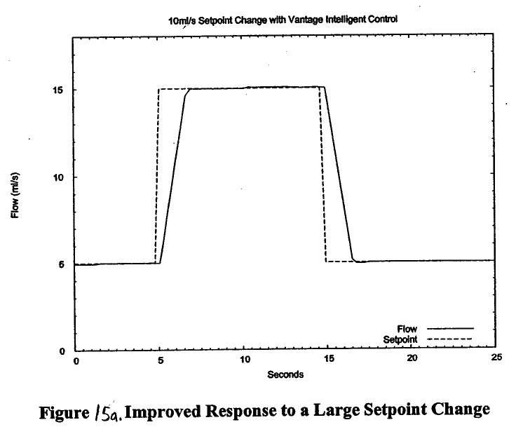

Turning now to FIG. 13, a system 200 is shown for controlling the flow rate of a closed loop variable orifice flow meter. The system includes a control valve block 205, which may be implemented with the variable orifice 14 in FIG. 12. The position sensor block 210 determines the actual and/or the implied position of the control valve block 205 to determine the size of the orifice and the resulting flow characteristics. The position sensor block may be implemented with the position sensor 110. Pressure sensing blocks 215 and 220 determine the downstream and upstream pressures relative to the control valve block 205, respectively. Such pressure sensing blocks may be implemented with the pressure sensors 124 and 122, respectively. The output of the pressure sensors 215 and 220, as well as the position information are provided to the controller block 225. The controller block 225 may be implemented with the microprocessor 102. The flow setpoint is also provided as an input to the controller block 225. A flow meter block 230 monitors the downstream flow output and provides this feedback to the controller block 225.

Still referring to FIG. 13, the flow characteristics of the valve are known by the controller block 225 over all inlet and outlet pressures at which the valve will operate, as well as all valve positions. These flow characteristics are known either by the design of the valve and/or determined empirically (e.g., are measured for each valve, for example as part of the manufacturing process). The temperature and type of fluid are also known by the controller block 225. The type of fluid is preferably known since the viscosity and density of the fluid, which varies with temperature, will affect the flow through the control valve block 205.

The following two equations express relationships for flow through the valve block 205:
F=f(T, ΔP, V) (Eq. 1)

Where:
F=Flow
T=Temperature
ΔP=Delta Pressure
V=Valve Position
   V=g(T, ΔP, F) (Eq. 2)

Where:
V=Valve Position
T=Temperature
ΔP=Delta Pressure
F=Flow

In order to perform a normal calculation of the flow through the valve block 205, Equation 1 is solved. Equation 2 is generated by the design of the valve block 205, or by calibration of flow through each valve in the production process, as mentioned above. When a new setpoint is entered, or a flow loop condition changes, it results in a difference between the desired flow rate F′, and the actual flow rate. A new valve position that correlates to this desired flow rate is calculated using Equation 2 as shown below:
V′=g(T, ΔP, F′)

Having solved this equation, the controller block 225 can move the position of the variable valve of valve block 205 directly to this new position. This results in a very fast movement to the new position, as compared to the hunting for the new position that occurs with a PID algorithm.

The method of control using the system 200 shown in FIG. 13 along with Equation 1 and Equation 2 may be implemented in alternative manners. One preferred implementation includes a system in which the controller maintains the setpoint under normal operating conditions (e.g., small loop variations) through use of a PID control algorithm. However, when a change in the setpoint—or change in the loop operating conditions occurs—then the PID algorithm is suspended and equation 2 is solved. The controller block 225 then immediately moves the valve to position V′. Subsequent to this movement, the PID algorithm is then reset and commences operational control once more.

The amount of change in the setpoint or in the loop operating conditions that causes a suspension of the PID algorithm and a direct change of the valve position, can be set by the user, or may be a default value entered during manufacture of the controller.

One manner in which the system shown in FIG. 13 may be implemented is by not using a PID algorithm at all, but by solving Equation 1 and integrating the difference between the result and set point and adding it to the result of Equation 2. This integration is used to overcome the finite resolution of the position of the control valve block 205. If no integration is added, the control valve block 205 will simply be set to the position that is closest to producing the desired flow rate. This may be unacceptably inaccurate in some situations. By adding integration the valve position will be moved up and down in a manner that will produce an average flow rate that is equal to the desired flow rate. This is essentially the same function that the integration term in a PID algorithm performs during steady state control.

In this case, the valve position may dither around the discrete position of the control valve block 205. This type of dither action may be necessary if the discrete actual physical position does not equal the actual desired position. The dither type action thereby acts to approximate the actual desired position from one or more movements (“dithers”).

A second method for improving the loop response for the system shown in FIG. 13 may be used when the function g from Equation 2 is not known. In this case, numerical methods are used to calculate V′ using the function f from Equation 1, along with T, ΔP, and the desired flow rate F′.

A preferred implementation using Newton's Method is as follows:

1) Calculate the derivative of flow with respect to the valve position at the current temperature and differential pressure:

$$ⅆ F / ⅆ V = \frac{f ( T , Δ P , V + x ) - f ( T , Δ P , V - x )}{2 x} \qquad ( Eq . 3 )$$

Where x is a small valve position change with respect to the operating range of the valve.

2) Calculate the desired change in flow rate:
cF=F′−f(T, ΔP, V) (Eq. 4)

3) Calculate the new valve position:

$${V}^{′} = V + \frac{cF}{ⅆ F / ⅆ V} \qquad ( Eq . 5 )$$

If dF/dV varies significantly for the various valve positions, the above steps may be repeated with V replaced by the V′ that was just calculated in an iterative fashion. This may be done until the algorithm converges to the desired accuracy. Iterating this algorithm several times will still result in significantly improved loop response time when compared to a typical PID algorithm.

As with the first method above for improving the flow control response, this second method may be used in conjunction with a PID algorithm, or may be used independently with an integration term for generating an average flow rate that is equal to the flow set point.

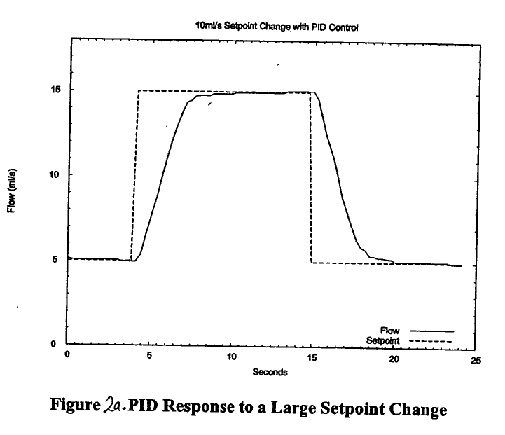

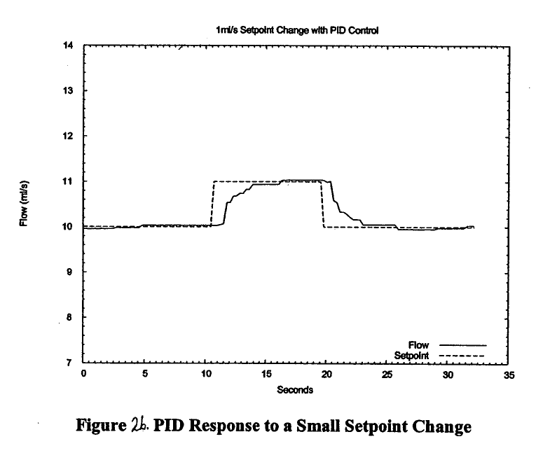

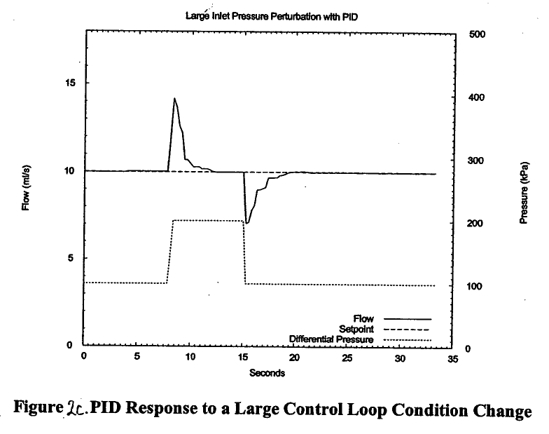

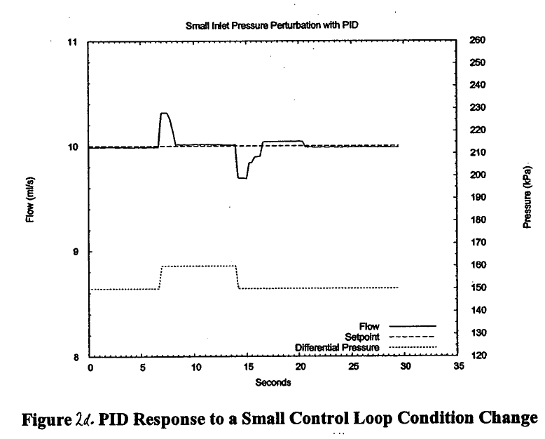

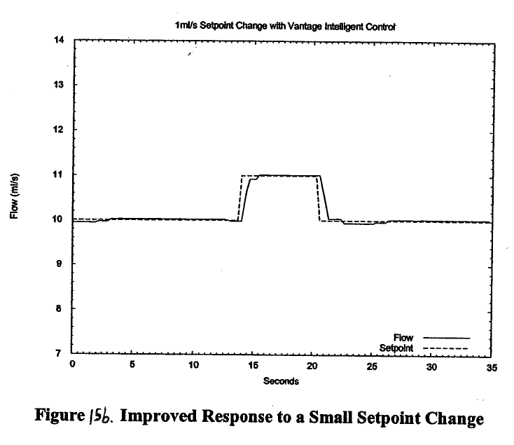

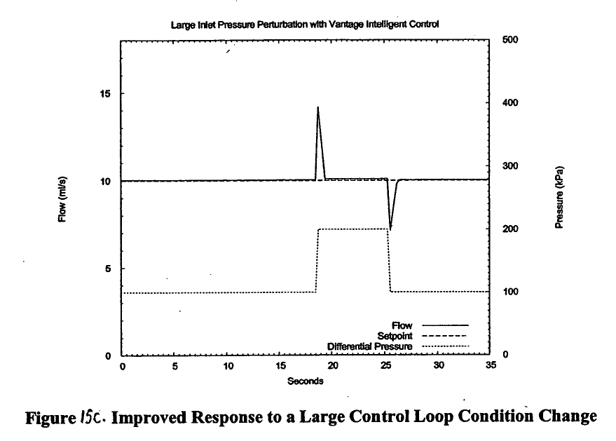

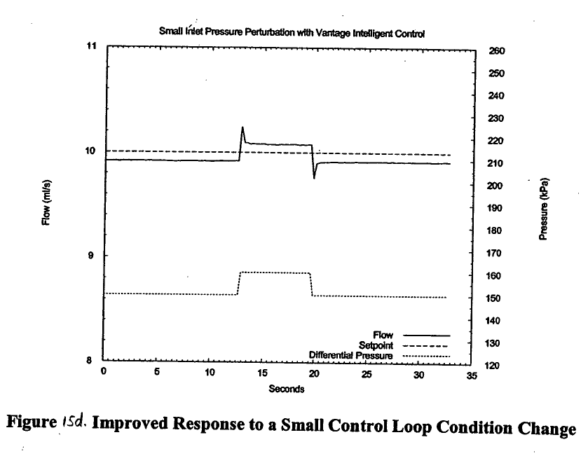

FIGS. 15a and 15b show the improved control loop response for setpoint changes that result when the second method described above is used. FIGS. 15a and 15b can be compared to the PID response plots shown in FIGS. 2a and 2b. FIGS. 15c and 15d show the improved control loop response for changes in the loop operating conditions that result when the second method described above is used. FIGS. 15c and 15d can be compared to the PID response to loop condition changes shown in FIGS. 2c and 2d.

In Operation

FIG. 14 illustrates the programming or logical flow steps that the controller block 225 may utilize in connection with determining whether to operate in direct mode or in a PID operation mode. The operation is shown generally at 300 and starts at block 301. Moving to block 302, the controller block 225 determines whether the set point has changed. If the answer is no, then the controller block 225 moves to block 303 and calculates the necessary PID control equations to determine if any change in the position of the control valve block 205 is necessary. After implementing any such changes, the controller block 225 returns to block 302.

If the answer at block 302 is yes, then the controller block 225 moves to block 304 in order to operate in direct mode for a series of cycles. At block 304, the number of cycles “i” is set to zero. At block 305, the direct mode calculation is made and the necessary change to the position of the control valve block 205 is implemented. Moving to block 306, “i” is incremented. If the answer is no, then the controller block 225 returns to block 305. Next at block 307, the controller block 225 determines if “i” has reached a predetermined number of cycles equal to “N”. This term N is employed to iterate to the correct position value. While ideally the correct position for a given flow set point and differential pressure could be reached with one orifice movement, in practice the differential pressure may change once the orifice has moved to a new physical position/opening. If the answer is yes, then the controller block returns to block 302.

It is also possible at block 302 to determine if there has been a change in the differential pressure across the control valve block 205. While the actual percentages are based on the performance required and/or desired by the user, for the type of system, and for the actual equipment and components employed, it is currently anticipated that a 30% change in the differential pressure may be used as the point to change from PID control to direct control.

While particular embodiments of the invention have been described with respect to its application, it will be understood by those skilled in the art that the invention is not limited by such application or embodiment or the particular components disclosed and described herein. It will be appreciated by those skilled in the art that other components that embody the principles of this invention and other applications therefore other than as described herein can be configured within the spirit and intent of this invention. The arrangement described herein is provided as only one example of an embodiment that incorporates and practices the principles of this invention. Other modifications and alterations are well within the knowledge of those skilled in the art and are to be included within the broad scope of the appended claims.

We claim:

1. A control system for controlling the flow of fluid through a variable orifice, the control system comprising:
a) a sensor for determining the pressure differential across the orifice and for creating a pressure signal;
b) a sensor for determining the position of a movable restrictive element and for creating a position signal, the element defining at least a portion of the orifice; and
c) a controller for monitoring the pressure signal and the position signal, the controller having a first control algorithm of PID control and a second control algorithm of direct movement of the movable restrictive element.

2. The system of claim 1, wherein the controller determines to switch between the PID control and the direct movement control based on determining that a predetermined change in pressure differential has been reached.

3. The system of claim 1, further comprising a first setpoint utilized by the controller.

4. The system of claim 3, further comprising a second setpoint utilized by the controller, wherein when the second setpoint is to be utilized, then the controller changes from the PID control to the direct movement control.

5. The system of claim 4, wherein the controller returns to PID control after a predetermined number of cycles.

6. The system of claim 5, further comprising an integration performed by the controller to approximate the actual desired position of the moveable restrictive element when the moveable restrictive element is limited to a discrete position which is not equal to the actual desired position.

7. The system of claim 6, wherein the integration takes the form of a dither by the moveable restrictive element about the actual desired position.

8. The system of claim 7, wherein the second setpoint is entered manually by a user.

9. The system of claim 1, further comprising a first and a second setpoint utilized by the controller, and wherein the controller determines to switch between the PID control and the direct movement control based on at least one of determining that a predetermined change in pressure differential has been reached or when the second setpoint is to be utilized.

10. The system of claim 1, further comprising a sensor for measuring the temperature of the fluid and for creating a temperature signal, wherein the sensor monitors the temperature signal.

11. A method of metering fluid flow through a variable orifice, the method comprising the steps of:
controlling a restrictive element located within the orifice to vary the cross-sectional area defined by the variable orifice;
measuring a pressure differential across the variable orifice; and
switching between a first control algorithm and a second control algorithm when a predetermined pressure differential is reached.
